(19) United States
(12) Patent Application Publication
(10) Pub. No.: US 2008/0286149 A1
(43) Pub. Date: Nov. 20, 2008

(54) BODILY FLUID SAMPLING WITH TEST STRIPS HINGED ON A TAPE

(76) Inventors: Steven N. Roe, San Mateo, CA (US); Hans Detlef Meyer, Gruenstadt (DE); Juergen Rasch-Menges, Schwetzingen (DE); Paul Jansen, Mannheim (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/747,947

(22) Filed: May 14, 2007

(51) Int. Cl. G01N 31/22

(52) U.S. Cl. 422/58

(57) ABSTRACT

A supply of test strips for bodily fluid sampling are provided on a tape such that advancing the tape serves to advance the test strips. One end of the test strips are attached to the tape, and their free end is allowed to extend away from the tape for use. This extension facilitates dosing and reduces the chances for contamination. Prior to use the test strips are maintained in a sealed container and/or under a removable covering to preserve their integrity and improve shelf life.

### BACKGROUND

The present invention generally relates to a supply of test strips for analyzing liquid samples, such as a bodily fluid. More specifically, but not exclusively, the present invention concerns a supply of sterile test strips carried on a tape where the test strips can be selectively extended from the tape to facilitate contact with the liquid sample.

Testing media or test elements are widely used in bodily fluid sampling, for example in blood sugar determination or in immunological testing (e.g. the detection of drugs, HCG, or HIV in blood and urine). Test elements are also used in environmental analysis and in other fields as well. Test elements typically operate by contacting a liquid sample to determine the amount of an analyte in the sample, taking advantage of a reaction between the liquid to be tested and a reagent present in the test element. For example, an optical test element will generally rely upon a color change, i.e., a change in the wavelength absorbed or reflected by dye formed by the reagent system used. In others types of test elements, a chemical change in the test element might be evaluated electrochemically.

Contacting the test element with the liquid is referred to as “dosing” the test element, and common methods of dosing are to apply a droplet of the liquid to the test element (e.g. blood glucose monitoring) or to dip the test element into the sample liquid (e.g. urine analysis, environmental analysis). To facilitate dosing and the sequent handling of the test element for analysis, the test element is typically mounted on a support. The test element and support are together known as a test strip. Rather than storing test strips individually, it is desirable to have a device that is capable of storing a supply of test strips and then providing the test strips on demand. Furthermore, where disposal of used test strips pose a safety or health concern (e.g. where biological fluids are involved), it is also desirable for such a device to provide for the secure storage of used test strips until appropriate disposal can be achieved.

However, there are challenges in designing such devices for handling a supply of test strips. For example, care must be taken to reduce the chances of contamination from one test to the next. In addition, when stored for long periods of time, moisture and other elements in the atmosphere can lead to reagent decomposition in many test elements. Furthermore, excessive mechanical stresses during manipulation of the test strips can compromise the integrity of the test elements. Finally, it is desirable for the device to be easy to use. The present invention is directed to addressing these challenges in a novel manner while also providing a design that is efficient and cost effective to manufacture.

### SUMMARY

The present invention provides novel systems and techniques for testing a bodily fluid. While the actual nature of the invention covered herein can only be determined with reference to the claims appended hereto, certain aspects of the invention that are characteristic of the embodiments disclosed herein are described briefly as follows.

According to one aspect, a device for the sequential provision of sterile test strips to analyze a bodily fluid sample is provided comprising a carrying tape having a supply section and an exposure section and a plurality of test strips sequentially carried from the supply section to the exposure section by advancement of the carrying tape. The test strips are exposed to a surrounding atmosphere while in the exposure section but are relatively not exposed to the surrounding atmosphere while in the supply section. The test strips are coupled to the tape such that, when in the exposure section of the carrying tape, a test strip is in an extended orientation relative to the carrying tape to facilitate contact with the bodily fluid sample. In one refinement, the device includes a housing defining a sterile compartment for containing prior to use, and at least one deformable member, such as a lip seal or a wheel, may be provided at the opening of the sterile compartment to help maintain the integrity of the sterile compartment. In another refinement, a removable covering is provided over the test strips in the supply section to help maintain the sterility of the test strips prior to use. A take up reel may be provided for peeling the covering from the tape to expose the test strips for use and/or the covering may be made penetrable by the test strips. While in the supply section, the tape may be configured in a series of bends or wrapped around a supply reel.

In another aspect, a method of analyzing a fluid is provided comprising providing a cassette of test strips carried on a tape, wherein unused test strips are substantially isolated from moisture in the surrounding environment by a covering; peeling the covering from the tape to at least partially expose a selected test strip; extending a portion of the exposed test strip from the tape; and contacting a fluid to the extended portion of the exposed test strip. A sensor then reads the test strip to determine a property of the fluid. The sensor may read the strip while the strip is in its dosing position or the tape may be advanced to bring the test strip to the sensor.

In another aspect, a method of sampling a bodily fluid is provided comprising providing a plurality of test strips serially positioned along a tape wherein at least a portion of the test strips are initially contained in a vapor tight chamber of a housing; advancing the tape through a moisture barrier at an opening to the vapor tight chamber to remove a first test strip from the vapor tight chamber; extending a free end of the first test strip from the tape; and contacting a bodily fluid to the extended free end of the test strip. The moisture barrier may include a deformable member, e.g. a wheel or a lip seal, positioned at the outlet at the opening of the chamber. The tape may be provided in the vapor tight chamber in the form of a series of alternating bends.

In another aspect, a device for the sequential provision of test strips for analysis of bodily fluids comprises a tape having a supply section and an activating section. The supply section includes a series of alternating bends in the tape for compact storage, and the activating section includes a bend to extend an end of a test strip from the tape for use. The test strips may be positioned in the supply section of the tape with only one test strip between each successive bend. First ends of the test strips may be coupled to the tape with adhesive, a clip, laser welding, or some combination thereof. Means may be provided to protect the test strips in the supply section from exposure to moisture in the environment, such as by provision of a removable covering and/or by positioning of the supply section in sterile compartment.

These and other aspects are discussed in more detail below.

### BRIEF DESCRIPTION OF THE FIGURES

Although the characteristic features of this invention will be particularly pointed out in the claims, the invention itself, and the manner in which it may be made and used, may be better understood by referring to the following description taken in connection with the accompanying figures forming a part thereof.

FIG. 1 is a partial sectional view of a device for analyzing fluids according to an embodiment of the invention.

FIG. 2 is a side view of a test strip attached to the carrying tape of FIG. 1.

FIG. 3 is a side view of a test strip attached to a carrying tape with a piece of adhesive tape folded on the underside of the test strip.

FIG. 4 is a top view of a test strip attached to a carrying tape with adhesive tape wrapped around the test strip and the tape.

FIG. 5 is a general diagrammatic view of another embodiment of the present invention.

FIG. 6 is a top view of a test strip tape having a removable cover for use in the FIG. 5 device.

FIG. 7 is a top view of an alternative arrangement for the tape of FIG. 6.

FIG. 8 is an enlarged side view of the storage reel section of the FIG. 5 device.

FIG. 9 is a top view of the storage reel section as indicated in FIG. 8.

FIGS. 10A and 10B are enlarged side views of an alternative arrangement for the exposure section of the FIG. 5 device prior to dosing (FIG. 10A) and with the test strip extending from an opening in position for dosing (FIG. 10B).

FIG. 11 shows a partial sectional view of an alternative arrangement for the supply section of the carrying tape.

### DESCRIPTION OF THE ILLUSTRATED EMBODIMENTS

For the purposes of promoting an understanding of the principles of the invention, reference will now be made to the embodiments illustrated in the drawings and specific language will be used to describe the same, with like reference numerals used to designate like features of the drawings. It will nevertheless be understood that no limitation of the scope of the invention is hereby intended. Alterations and further modifications in the illustrated devices, and such further applications of the principles of the invention as illustrated herein, are contemplated as would normally occur to one skilled in the art to which the invention relates.

In one form, the present invention provides a fluid testing device including a plurality of test strips serially carried on a tape wherein the test strips are connected to the tape at only one of their ends. During fluid sampling, the free end extends from the tape and allows the test element that is carried on the test strip to be brought closer to the fluid being sampled without risking contamination to the remainder of the device. Before use, the test strips are kept sterile and protected in a supply section of the tape. In a particular form, the supply section is contained in a sterile compartment of a housing that is substantially isolated from the external atmosphere. In another particular form, the supply section of the tape is covered by a sterile covering that is peeled away to expose the underlying test strips.

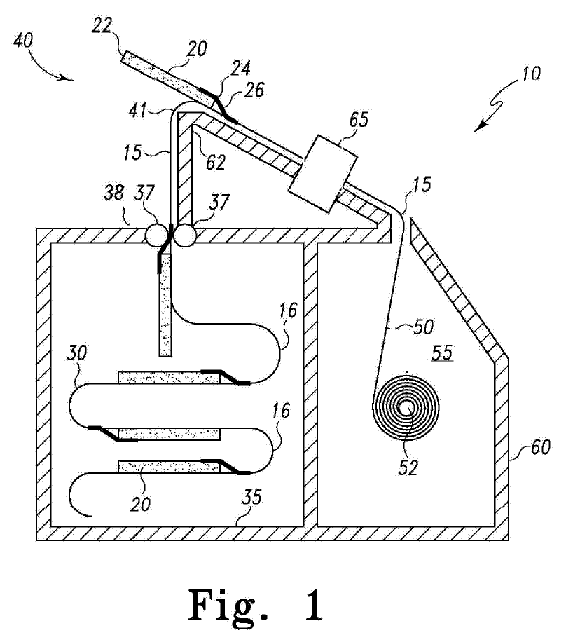

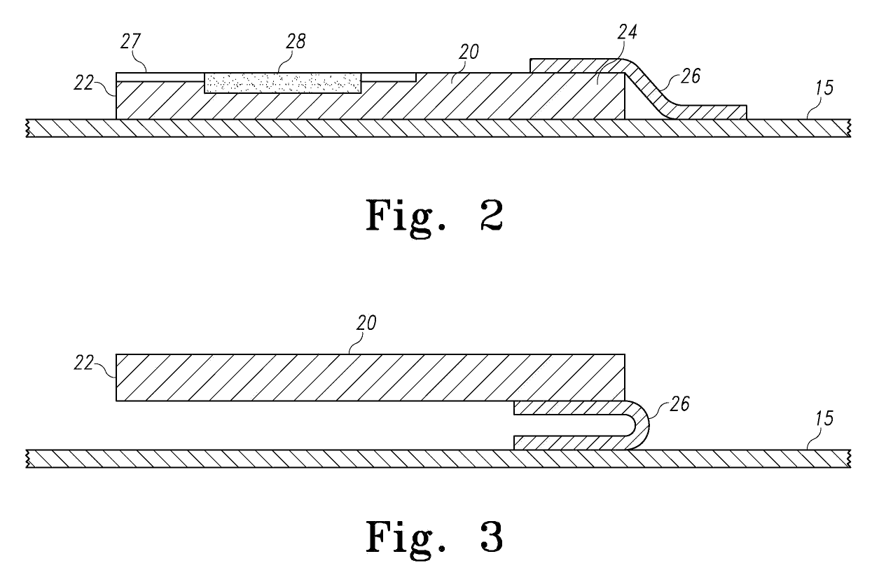

Turning now to FIGS. 1 and 2, device 10 for use in analyzing fluids according to one embodiment is depicted. Device 10 includes a plurality of test strips 20 mounted on a carrying tape 15. The tape 15 is mounted in a housing 60 and defines a supply section 30, an exposure section 40, and a storage section 50. The test strips 20 are serially mounted along the tape 15 so as to be advanced one by one from the supply section 30, where they are stored prior to use, to the exposure section 40, where they are dosed with the fluid. After dosing, the test strips are read with a sensor 65 and then advanced into the storage section 50. As depicted, the tape 15 would be advanced to bring the now-dosed test strip into engagement with the sensor 65, but the sensor can also be positioned to read the test strip when the test strip is in its dosing position.

The carrying tape 15 is thin and flexible yet it is sturdy enough so as not to break during use. The tape 15 can be constructed of a single elongated flexible material, such as a plastic, fabric, metal foil, or tissue, or it may be composed of multiple materials. In one form, the tape is constructed from multiple sections of relatively rigid material that is flexibly linked together in the form of a chain. In other forms, a series of perforations can provide the requisite flexibility to the tape. The tape may include feed holes (not shown) along it perimeter to engage corresponding gears (not shown) on the driving wheels. The tape 15 can also include a bar code, a punch code, a magnet tape, an RFID tag, and/or it can have corrugations for coding relevant information about the strip (e.g. lot number, expiration date, reagent calibration information).

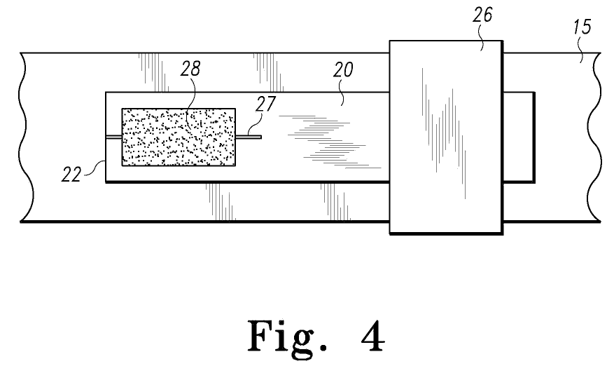

The test strips 20 are attached or otherwise connected to the carrying tape 15 at their proximal ends 24. The distal ends 22 of the test strips 20 are unconnected to the tape 15. As illustrated in FIG. 2, the coupling between the proximal end 24 and the tape 15 may be via a connector, such as a piece of adhesive tape 26 attached between the upper surface of the test strip 20 (i.e. the side away from the tape 15) and the carrying tape 15. An alternative manner of using adhesive tape is depicted in FIG. 3, wherein the adhesive tape 26 is folded under the test strip 20 so as to contact the under surface (i.e. the side facing the tape 15) and the carrying tape 15. A further variation is depicted in FIG. 4, wherein the connecting tape 26 is wrapped around the test strip 20 and the carrying tape 15 in a direction transverse to the elongated longitudinal length of the carrying tape 15. Other means of coupling the strips 20 to the tape 15 that may be employed include tacks, clips, a pressure or heat sensitive adhesive or glue, or laser welding or fusion.

The test strip 20 can be any of the various types of test strips known in the art, and with reference to FIG. 4, it may include a capillary groove 27 or passage to facilitate drawing the liquid sample from the distal end 22 into a chamber containing the test media 28. It is to be understood that the exposure section 40 of the carrying tape 15 passes around a corner 62 to create a bend 41 in the tape 15. Because the distal end 22 of the test strip 20 is not connected to the tape 15, when a test strip passes around this bend 41, the distal end swings out from the tape 15 to an extended orientation relative to the tape 15 (e.g. the uppermost test strip shown in FIG. 1). Because it is the extended distal portion of the test strip that includes the test element 28 and the entrance thereto, the relative spacing between the carrying tape 15 and the test element 28 in the extended orientation of the test strip 15 facilitates dosing while reducing the chances that excess sample liquid will contaminate other portions of the tape 15 or the device 10.

A common medical test, and one for which the present invention is particularly but not exclusively applicable, is the measurement of blood glucose level. The glucose level can be determined directly by analysis of the blood or indirectly by analysis of other fluids such as interstitial fluid. Diabetics are generally instructed to measure their blood glucose level several times a day, depending on the nature and severity of their diabetes. Based upon the observed pattern in the measured glucose levels, the patient and physician determine the appropriate level of insulin to be administered, also taking into account such issues as diet, exercise, and other factors.

In testing for the presence of an analyte such as glucose in a bodily fluid, the test system can take advantage of an oxidation/reduction reaction which occurs using an oxidase/peroxidase detection chemistry. In this form, the test media 28 is exposed to a sample of the bodily fluid for a suitable period of time, and there is a color change if the analyte (glucose) is present. Typically, the intensity of this change is proportional to the concentration of analyte in the sample. After the dosing, the tape 15 is advanced to bring the test strip 20 into the sensor 65 (or the sensor can be positioned to be in contact with the test strip during dosing). The sensor may be an optical sensor such as a reflectance spectrophotometer operating at a selected wavelength, which serves to compare the color of the reagent to a known standard to determine the amount of analyte present in the sample. Electrochemical and other systems could also be employed. Once the testing is complete, the tape is advanced into the storage section 50 where it is wound around a storage reel 52 inside a storage chamber 55 of the housing 60.

It is to be appreciated that the storage reel 52 can be operated automatically with a battery operated actuator (not shown) or manually with a hand crank (not shown), and it is the winding of the storage reel 52 that serves to advance the carrying tape 15. One or more opposed resilient lips or deformable rollers 37 are disposed at the opening to the supply chamber 35 of the housing 60. As the reel applies tension to the tape 15, these rollers 37 pinch the tape 15 and provide resistance to its movement sufficient to maintain the exposure section 40 of the tape 15 in tension as it is being wound onto the reel 52.

The rollers 37 also function as sealing means at the exit 38 of the supply chamber 35. In other words the rollers 37 serve to substantially seal the supply chamber 35 from the surroundings and particularly from the moisture in the surrounding atmosphere. This serves to protect the test elements in the supply chamber 35 from degradation. As illustrated, the sealing means is a pair of rollers 37. Other sealing means may be provided at the outlet of the supply chamber 35, for example a lip seal constructed from a single lip or a pair of opposed lips biased into a closed position, for example as described in U.S. application Ser. No. 10/871,943 filed Jun. 18, 2004.

In general the sealing means may include at least one resilient member positioned at the exit 38 of chamber 35 that deforms to allow passage of the tape 15 and test strip 20 and prevents or restricts the inflow of contaminates. The resilient member may be made from any suitable material such as rubber, deformable plastic, or a thermoplastic elastomer such as Santoprene®, available from Advanced Elastomer Systems, Akron, Ohio. Preferably but not essentially the sealing means is substantially air tight when at rest (i.e. when a test strip is not actively being passed through the sealing means) to restrict the inflow of airborne contaminates during the times the device is not in use. The supply chamber 35 includes a material (not shown) to absorb or adsorb airborne contaminates (e.g. a desiccant material) such that the concentration of airborne contaminates in the chamber 35 is made to be substantially less than the concentration of such contaminates outside the chamber 35. The sealing means may then function to restrict the reintroduction of such contaminates from the surrounding atmosphere, thereby preserving the integrity of the test strips and extending their useful life.

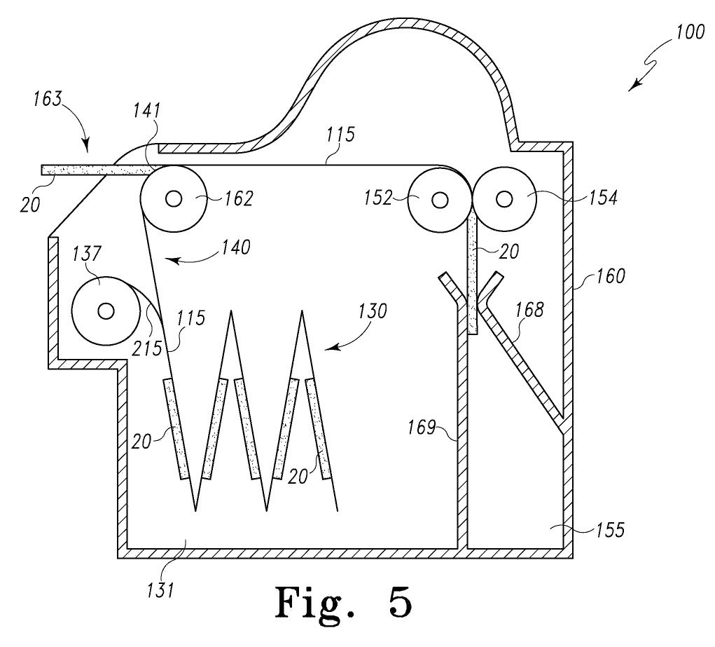

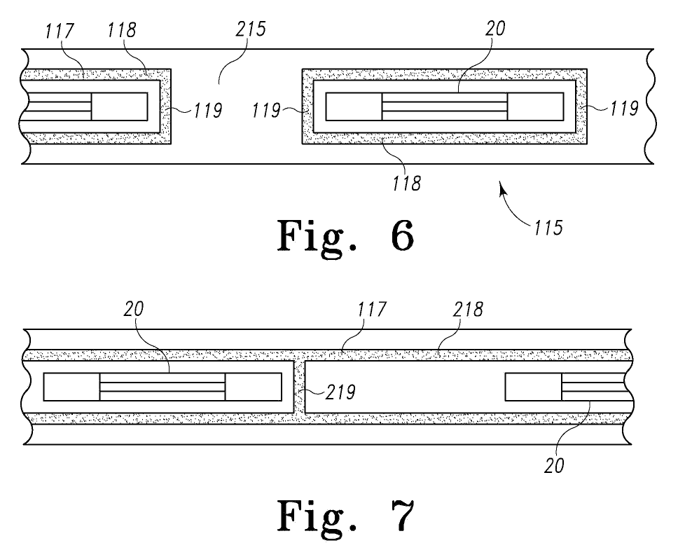

Other means may be employed to protect the integrity of the unused test strips. For example, as described more fully with respect to FIGS. 5 and 6 below, a removable covering can be employed to protect the test strips from moisture or other harmful elements in the atmosphere. Such a removable covering can be employed in place of or in addition to the supply chamber 35 having sealing means at its exit 38.

The supply section 30 of the carrying tape 15 is configured in a series of alternating bends 16, i.e. the tape bends in alternating directions. This accordion folded pattern can serve multiple purposes. It is a compact storage configuration for the test strips in the supply section 30 and thus serves interests of compactness. Additionally, in many applications the test strips will be more rigid than the tape. In these applications, this accordion fold pattern helps maintain the mechanical integrity of the test strips 20 by avoiding imposition of substantial mechanical stresses during storage. In other embodiments, the supply section 30 of the tape 15 may take the form of a roll or coil of the test strips. In these embodiments, the test strips may experience slight deformation and should be designed to be robust enough that any such pre-use deformation does not compromise their integrity. It is preferable, though not essential, that irreversible deformation of the test strips during storage be avoided.

As illustrated in FIG. 1, the test strips 20 are stored horizontally (as per the FIG. 1 view) in chamber 35 and then rotate to vertical as they are drawn through the generally centrally located exit 38 on the upper wall of chamber 35. There is one bend 16 in tape 15 between each of the test strips 20 such that their distal ends alternate between being on the left or right of the horizontal stack of strips. Other packing arrangements and configurations of chamber 35 are contemplated. For example in FIG. 11, the exit 38a of supply chamber 35a is near a corner. Strips 20 in supply section 30a are positioned such that there are two bends 16 between each strip 20 and the distal ends 22 of the strips 20 are aligned. As a result, in the FIG. 11 supply section 30a, the strips do not undergo a significant orientation change as they are drawn through the exit 38a. Accordingly, while the FIG. 11 arrangement may necessitate the use of more tape 15 (due to the length between folds 16 where there is no test strip 20), the FIG. 11 arrangement can provide more dense packing of strips 20.

It is to be appreciated that an aspect of the invention is the fact that at the corner 62, the path of the tape changes direction (i.e. turns a bend). This turn or change of direction causes the free end of the test strip to extend away from the tape 15. While in the illustrated embodiment, the leading end (i.e. end 24) of the test strip is attached to the tape 15 and the trailing end (22) is free, the device 10 could be designed such that the trailing end of the test strip is connected and the leading end is free. In such an alternative embodiment, the free end will be in the extended orientation before the connected end reaches the bend 41 caused by corner 62, rather than after, as occurs in the illustrated embodiment.

Furthermore, while the bend 41 in the exposure section 40 of the tape is caused by the relatively fixed corner 62, in other embodiments, the bend 41 is created by a roller. In still further forms, the bend 41 is formed by a pivoting member and is a portion of a service loop, for example as described with respect to lancets carried on a tape in commonly owned U.S. application Ser. No. 10/836,578.

Turning now to FIG. 5, a test strip device 100 utilizing a removable covering to preserve the integrity of the unused test strips 20 is depicted. Device 100 includes a housing 160 that defines compartments 131, 155. Storage compartment 131 serves to store the supply of test strips before use, and supply compartment 155 stores them after use. Housing 160 contains a series of rollers that define a path for the tape 115 carrying the test strips 20. Like carrying tape 15 described above, carrying tape 115 is arranged to carry a supply of test strips 20 from a supply section 130, which is configured in an accordion fold pattern, to an exposure section 140, which is adjacent bend 141 provided by wheel 162.

Tape 115 further includes a cover 215 over the test strips 20 in the supply section 130. A take-up reel 137 is configured to peel off the cover 215 from the tape 115 to expose the underlying test strip 20 prior to use. The exposed test strip 20 extends away from the housing 160 at the bend 141 provided by wheel 162 and out opening 163 in housing 160. As explained above, this extension of the test strip 20 from the carrying tape 115 facilitates dosing of the strip 20.

After dosing, the test strip 20 is analyzed with an appropriate sensor(s) (not shown). There are a variety of ways sensors may be positioned in device 100. For example, a sensor can be positioned and arranged in device 100 to contact the test strip 20 in its dosing position, i.e. such that analysis occurs without further movement of the test strip 20 from its dosing position. Alternatively, the sensor may be positioned and arranged in device 100 such that movement of the tape 115 after dosing brings the now-dosed test strip into contact with the sensor. In certain advantageous forms, at least a dose sufficiency sensor (not shown) is provided in cooperation with the test strip when the test strip is in its dosing position. Dose sufficiency sensors are known in the art and function to ascertain when an adequate amount of sample fluid has been received in the test strip 20.

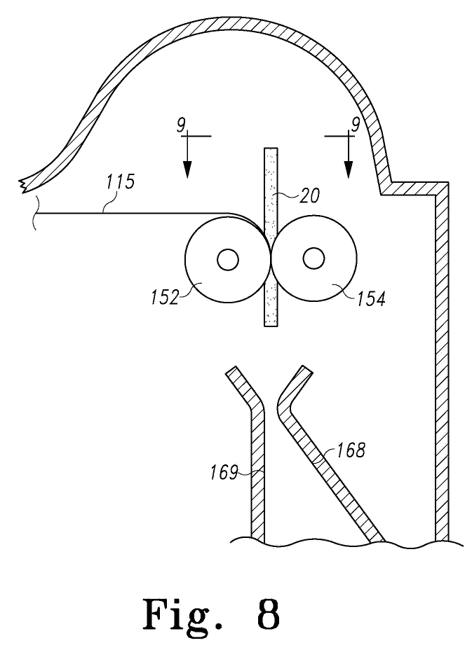

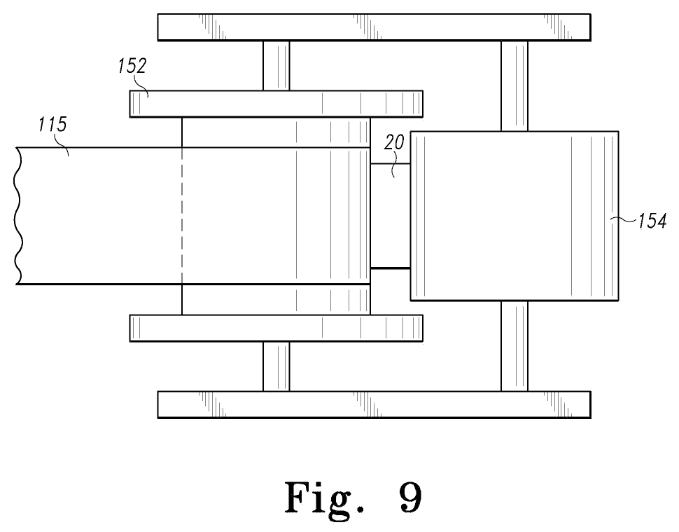

After dosing and measurement, the used test strip 20 is discarded. The carrying tape 115 is wound around a storage reel 152, and a pinch wheel 154 positioned adjacent the storage reel 152 dislodges the used test strip 20 through the flared opening defined by members 168, 169 and into the storage compartment 155. As shown in FIGS. 8 and 9, the pinch wheel 154 operates to dislodge the used strip 20 from the carrying tape 115 by preventing the strip 20 from swinging completely around the bend created by the storage reel 152. In other words, the pinch wheel 154 retains the strip 20 in the upright orientation (as shown in FIG. 8), while the carrying tape 115 is wound around the storage reel 152. The rigidity of the test strip is sufficient to overcome the connection force between the proximal end of the strip 20 and the carrying tape 115 such that this continued winding of the tape 115 around reel 152 while the strip is held in the upright orientation causes the connection between the strip 20 and the tape 115 to be severed.

Alternatively, used test strips could also be remagazined by rolling or folding used tape into a magazine. In still further forms, the tape can be cut or shredded automatically within the device 100.

Referring to FIG. 6, the tape 115 is a multi layer tape. A base layer holds the test strips 20 and a cover layer 215 covers the test strips 20. The cover layer 215 has sections 117 that are sealed to the base layer in a perimeter around each test strip 20. As illustrated in FIG. 6, the perimeters around each test strip 20 may be distinct, having two edge sections 118 that run parallel to the tape edge and which are joined by two traversing sections 119 at the proximal and distal ends of each test strip 20. Alternatively, as depicted in FIG. 7, extended edge sections 218 may run along side multiple test strips 20 (e.g. substantially the entire length of the tape 115) with traversing sections 219 separating the test strips into individual compartments.

Sealed sections 117 may be formed in a variety of ways, for example by heat sealing (e.g. a laser sealing process) or contact sealing. The seal is sufficient to prevent moisture of other contaminates from degrading the test strip, and the seal in at least the traversing sections 119, 219 can be broken to allow the covering tape layer 215 to be peeled away by the take up reel 137. Alternatively, the test strips and cover layer 215 can be constructed such that the test strip punctures through the cover layer 215 as it goes around a bend, such as bend 41 of FIG. 1.

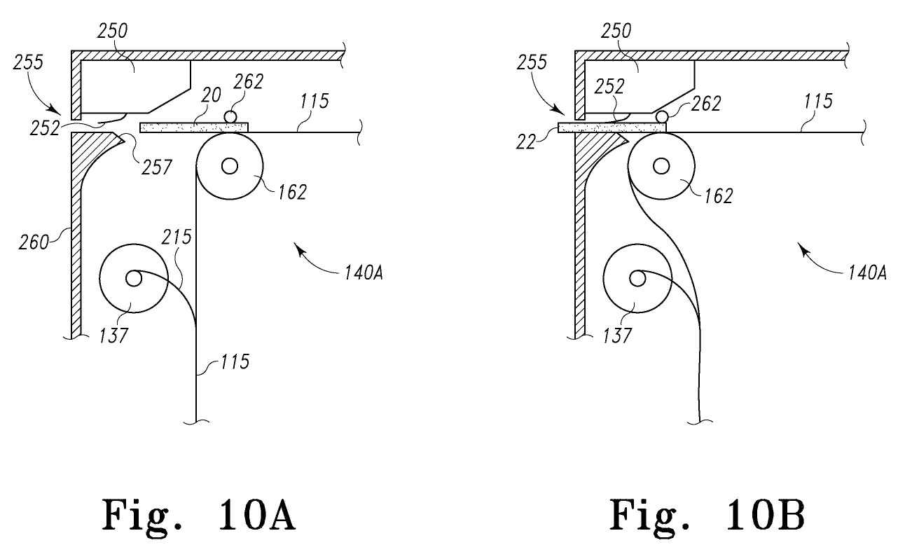

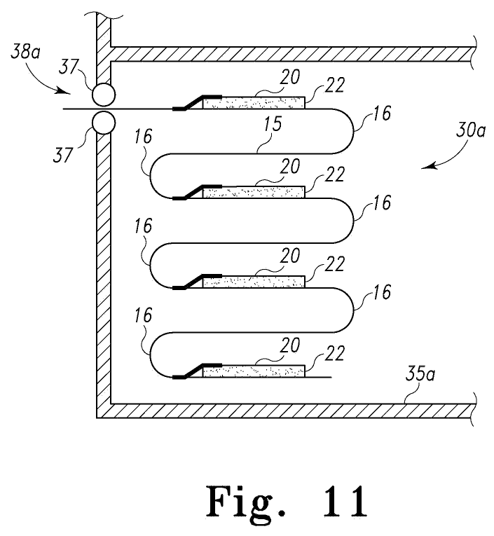

An alternative arrangement for the exposure section 140 of device 100 is depicted in FIGS. 10A and 10B. Exposure section 140a operates similar to exposure section 140 of FIG. 5 in that take up reel 137 removes cover 215 from carrying tape 115 to expose a test strip 20, and at the exposure section 140a, the distal end of test strip 20 extends from the corner created by wheel 162. However, as shown in FIG. 10A, the distal end of test strip 20 does not extend from opening 255 in housing 260 when the test strip 20 first extends from the corner created by wheel 162. Rather, the test strip 20 is grasped between wheels 262 and 162 and pushed out opening 255 to the dosing position shown in FIG. 10B.

A sensor 250 with test strip contacts 252 is positioned inside the housing 260 near this dosing opening 255. A guide member 257, which may be hinged to avoid interfering with the initial extension of the test strip 20 from the tape 115, helps direct the distal end of test strip 20 out the opening 255 and helps assure proper engagement between test strip 20 and sensor contacts 252 when test strip 20 is in its dosing position (FIG. 10B). The sensor 250 may be configured to detect both dose sufficiency and analyte concentration and then communicate this information to the user.

As illustrated, the wheels 262, 162 grasp the test strip 20 and translate with the test strip 20. This serves to longitudinally project the test strip out opening 255. Alternatively or in addition, the wheels 262, 162 may rotate backwards to push the distal end of test strip 20 towards opening 255. In still further configurations, the mechanism for translating the test strips 20 out of the opening 255 once the test strip 20 has been extended from tape 115 is independent of wheel 262. For example sensor 250 may be configured to engage with test strip 20 in its position of FIG. 10A, and the sensor 250 may provide the force to translate the distal end of test strip 20 out of opening 255. Regardless of the mechanism of action, it is desirable to reduce the energy required to move the test strip out opening 255, which energy may be provided by the user (e.g. by manually depressing levers or turning wheels) or by an on board battery carried by the device 100. For example, the take up reel 137 may be selectively released to allow the carrying tape 115 to be pulled backwards (i.e. towards the left in FIG. 5) or unwound without resistance.

As illustrated in FIG. 10B, sensor 250 is positioned on the top of test strip 20. It may also be positioned below and/or to the sides of test strip 20.

It is to be understood that the movement of test strips on a tape described herein may be accomplished automatically or manually and may be utilized in a stand alone test strip dispenser or in integrated devices (i.e. meters with integrated test strip supply). For automatic operation in an integrated device, test strips may be advanced and positioned for use upon an activation signal (e.g. from the push of a button). Subsequent signals, generated from another button push or determined by the occurrence of certain events (e.g. the determination of dose sufficiency), may trigger advancement of the test strips to a measurement station or, upon completion of the test, a storage compartment.

### CLOSURE

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any theory, mechanism of operation, proof, or finding stated herein is meant to further enhance understanding of the present invention and is not intended to limit the present invention in any way to such theory, mechanism of operation, proof, or finding. Thus, the specifics of this description and the attached drawings should not be interpreted to limit the scope of this invention to the specifics thereof. Rather, the scope of this invention should be evaluated with reference to the claims appended hereto.

In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Likewise, where the term “input” or “output” is used in connection with an electric device, it should be understood to comprehend singular or plural and one or more signal channels as appropriate in the context. Finally, all publications, patents, and patent applications cited in this specification are herein incorporated by reference to the extent not inconsistent with the present disclosure as if each were specifically and individually indicated to be incorporated by reference and set forth in its entirety herein.

What is claimed is:

1. A device for the sequential provision of sterile test strips to analyze a bodily fluid sample, comprising:
a carrying tape having a supply section and an exposure section;
a plurality of test strips sequentially carried from the supply section to the exposure section by advancement of the carrying tape; and
means for restricting the exposure of the test strips in the supply section to a surrounding atmosphere, said means comprising at least one of: a sterile compartment of a housing that contains the supply section and has a deformable seal at its exit, and a removable covering over the test strips in the supply section;
wherein the test strips have proximal and distal portions, the proximal portions of the test strips being coupled to the carrying tape;
wherein when in the exposure section of the carrying tape, a test strip is in an extended orientation relative to the carrying tape and exposed to the surrounding atmosphere, the extended orientation involving the distal portion of the test strip extending away from the carrying tape to facilitate contact with the bodily fluid sample.

2. The device of claim 1 wherein a housing that contains the supply section and has a deformable seal at its exit is provided, the deformable seal comprising at least one deformable member that maintains the integrity of the sterile compartment by restricting the influx of airborne contaminates into the sterile compartment.

3. The device of claim 1 wherein a removable covering over the test strips that are in the supply section of the carrying tape is provided.

4. The device of claim 3 further comprising a covering removal device adapted to peel the covering from the carrying tape when the carrying tape is advanced.

5. The device of claim 1 further comprising a housing having an opening through which the distal portion of a test strip in its extended orientation at least partially extends.

6. The device of claim 5 wherein the distal portion of a test strip does not extend from the opening unless the tape is translated in a direction different than the direction of tape advancement.

7. The device of claim 1 further comprising a wheel adjacent a storage section of the carrying tape, wherein the wheel is configured to remove used test strips from the carrying tape.

8. The device of claim 2 wherein the supply section of the carrying tape is configured in a series of alternating bends.

9. The device of claim 3 wherein the supply section of the carrying tape is configured in a series of alternating bends.

10. A method of analyzing a fluid comprising:
providing a cassette of test strips carried on a tape, wherein unused test strips are substantially isolated from moisture in the surrounding environment by a covering;
peeling the covering from the tape to at least partially expose a selected test strip;
advancing the tape in a first direction around a bend to extend a portion of the exposed test strip from the tape; and
contacting a fluid to the extended portion of the exposed test strip.

11. The method of claim 10 further comprising:
prior to the contacting, moving the tape in a second direction different than the first direction to cause the extended portion of the exposed test strip to at least partially project through an opening in a housing.

12. The method of claim 11 wherein the fluid is a bodily fluid, the method further comprising determining at least one property of the bodily fluid with a sensor.

13. The method of claim 10 wherein the peeling includes winding the covering around a take-up reel.

14. The method of claim 10 wherein the test strips are substantially more rigid than the tape and the unused test strips are provided in a supply section of the tape that is configured in a series of bends in alternating directions, the method further comprising unbending at least one of the bends in the supply section to advance a test strip from the supply section.

15. The method of claim 14 wherein a multiplicity of test strips are positioned in the supply section in stacked arrangement with two bends between each test strip.

16. The method of claim 14 further comprising, after the contacting, removing the used strip from the tape.

17. A method of sampling a bodily fluid comprising:
providing a plurality of test strips serially positioned along a tape wherein at least a portion of the test strips are initially contained in a sterile chamber of a housing having a deformable seal at its exit;
advancing the tape in a first direction to withdraw a first test strip from the sterile chamber through the exit;
positioning the tape around a bend to extend a free end of the first test strip from the tape; and
contacting a bodily fluid to the extended free end of the test strip.

18. The method of claim 17 further comprising:
before the contacting, moving the tape in a second direction different than the first direction to project at least a portion of the extended free end of the test strip from an opening in a housing.

19. The method of claim 18 wherein the tape is provided in the sterile chamber in the form of a series of alternating bends.

20. A device for the sequential provision of test strips for analysis of bodily fluids comprising:
a tape having a supply section and an activating section, wherein the supply section includes a series of bends in the tape in alternating directions and wherein the activating section includes an activating bend in the tape; and
a plurality of test strips carried by the tape and containing a test element for determining at least one property of the bodily fluid, wherein the test strips have a proximal portion coupled to the tape and a distal portion uncoupled to the tape such that their distal portion extends from the tape when the test strip is adjacent the activating bend in the tape.

21. The device of claim 20 wherein the test strips are positioned in the supply section of the tape with at least one test strip between successive bends.

22. The device of claim 20 wherein the proximal portions of the test strips are coupled to the tape with at least one of an adhesive, a clip, or laser welding.

23. The device of claim 20 wherein there are two bends of the tape between successive test strips in the supply section.

24. The device of claim 23 where test strips on the supply section of the tape are protected from exposure to moisture in the environment.

25. The device of claim 24 wherein the test strips on the supply section of the tape are protected by a removable covering.

26. The device of claim 24 wherein the test strips on the supply section of the tape are protected by containment in sterile compartment of a housing having a deformable seal at its exit.
